(19) United States
(12) Patent Application Publication
(10) Pub. No.: US 2026/0238941 A1
(43) Pub. Date: Aug. 13, 2026

(54) Sealing Determination Method and Device

(71) Applicant: ST R&DTech, LLC, Delray Beach, FL (US)

(72) Inventor: John KEADY, Fairfax Station, VA (US)

(73) Assignee: ST R&DTech, LLC, Delray Beach, FL (US)

(21) Appl. No.: 19/155,512

(22) PCT Filed: Feb. 10, 2024
(86) PCT No.: PCT/US24/15302

§ 371 Date: Aug. 11, 2025

Related U.S. Application Data
(60) Provisional application No. 63/444,942, filed on Feb. 11, 2023.

(51) Int. Cl. H04R 29/00; H04R 1/10; H04R 25/00

(52) U.S. Cl. CPC H04R 29/001; H04R 1/1016; H04R 1/1041; H04R 25/305

(57) ABSTRACT

Directed to a method of seal determination, by sending a first signal to a speaker; emitting audio content from the speaker in response to the speaker receiving the first signal, wherein the audio content is emitted into a chamber formed by a device inserted into a channel, wherein the speaker is in the device; measuring sound in the chamber with a microphone, wherein the microphone generates a microphone signal and wherein the microphone is in the device; converting the microphone signal into a spectrum; generating a ratio of intensities of the spectrum at a selected frequency, fs, and a multiple of the selected frequency mfs; and comparing the ratio to a threshold value to determine whether the device is adequately sealed in the channel.

### CROSS REFERENCE TO RELATED APPLICATIONS AND PRIORITY

The present application is a non-provisional of and claims priority to U.S. Provisional Patent Application No. 63/444,942, filed 11 Feb. 2023, the entirety of which is hereby incorporated by reference.

### FIELD OF THE APPLICATION

The present application relates to devices that test for seal quality of a device obstructing a channel, in particular a seal quality determination method for a device that at least partially a seal and ear canal.

### BACKGROUND

Many devices have been developed over time to deliver acoustic content to a user. Many of these devices take the form of an earphone (a device to deliver audio content directly to the ear, e.g., muff, earbud, in-ear system, hearing aid), which can be connected either wired or wireless to a computational device which delivers content or standalone (e.g., hearing aid).

Many of these devices are constructed to provide sound to a user's ears. In many of these devices, the quality of the functions depend on a decent seal of a user's ear canal, for example sound reduction features. Another example of a device where seal monitoring is useful is hearing aids. It is useful for hearing aids to monitor seal quality both for noise reduction functions, if used, and for adjusting the intensity profiles based upon a user's hearing loss profile as various noise leaks into the ear canal.

There are two references described and analyzed by the Patent Trademark and Appeal Board (PTAB) in IPR2022-00410 and IPR2022-00302 with regards to seal determination methods. The two references cited below are Ryan (US 2004/0196992), and Svean (U.S. Pat. No. 6,567,524) of which Svean is part of portfolio with similar descriptions and figures (U.S. Pat. Nos. 6,754,359, 6,728,385, US 20030165246, U.S. Pat. Nos. 6,661,901, 7,039,195).

### PTAB IPR2022-00302

### 1. Overview of Ryan (Ex. 1007) Ryan (US 2004/0196992)

Ryan discloses “a system and method for detecting the insertion and removal of a hearing instrument from the ear canal.” Ex. 1007 ¶ 12. The hearing instrument can be “any hearing aid, listening device or headset having an output that is delivered into a sealed ear (circumaural earcup) or ear canal (insert earphone, hearing aid, etc.).” Id. Ryan explains that, when a hearing instrument is initially fitted, or in later use, it “may not form a proper seal,” and “an audiologist or user may need to determine whether the hearing instrument has formed a proper seal.” Id. ¶ 5. To address this problem, Ryan teaches “[a] system for detecting the insertion and removal of a hearing instrument” from the ear canal, including “a loudspeaker driving into a sealed acoustic cavity, a microphone that is acoustically coupled to this sealed cavity, and signal processing circuitry used to determine if the cavity is sealed or not.” Id. ¶ 20.

Ryan's FIG. 3 depicts hearing instrument 10, having loudspeaker 20 for radiating acoustic energy into sealed acoustic cavity 12, and measuring microphone 30 for receiving a portion of the acoustic energy radiated by loudspeaker 20 and generating an electrical signal in response. Ex. 1007 ¶ 24. The system detects “when the cavity 12 is sealed” and also “simultaneously monitors the low-frequency signal levels at the input to the loudspeaker 20 to obtain a loudspeaker drive level . . . [and] an acoustic output level.” Id. ¶ 25. An “automatic system for detecting when the cavity 12 is sealed simultaneously monitors the low-frequency signal levels at the input to the loudspeaker 20 to obtain a loudspeaker drive level, and the low-frequency signal levels at the output of the microphone to obtain an acoustic output level.” Id.

As further shown in FIG. 3, loudspeaker 20 is coupled to first level detection circuitry 22 that receives the signal sent to loudspeaker 20 and generates first intensity signal ID. Ex. 1007 ¶ 25. Microphone 30 is coupled to second level detection circuitry 32 that receives the signal generated by microphone 30 and generates second intensity signal IO. Id. ¶ 26. Signal processing circuitry 40 (not shown in FIG. 3) compares signals ID and IO “to determine if the loudspeaker 20 is driving into a sealed acoustic cavity.” Id. ¶ 30. For example, “a ratio of these levels” may be “used to decide if the loudspeaker 20 is driving into a sealed acoustic cavity.” Id. “The expected ratio of the signal levels ID and IO under the sealed and unsealed conditions is derived from knowledge of the electro-acoustic transfer function from the loudspeaker 20 to the microphone 30 under the various operating conditions.” Id. ¶ 31. For example, “at a frequency of 200 Hz, a ratio of acoustic output to loudspeaker drive of about −3 dB would indicate a sealed cavity, and a ratio of −25 dB would indicate an open cavity.” Id. ¶ 32.

“ . . . Ryan's signal processing circuitry 40, which merely provides gain and power controls to an amplifier, rather than supply a signal which is (directly or indirectly) used to drive a speaker. Ex. 1007 ¶¶ 30-33 . . . ”

Thus in effect, Ryan does not compare two signals. Ryan uses signal levels I_{D} and I_{O} (each a single value), which are not in and of themselves signals (vectors of values versus time or frequency).

### PTAB IPR2022-00410

### 1. Svean Disclosure: Svean (U.S. Pat. No. 6,567,524)

Svean discloses a noise protection verification device received in a user's ear. See Ex. 1006, codes (54) and (57).

FIG. 1 of Svean, depicts a human user's outer ear, and an ear terminal inserted into the user's ear. See id. at 4:18-22, 4:64-67. The ear terminal comprises outer section 1 and sealing section 2, whereby receipt of sealing section 2 within the ear forms a seal to attenuate external sounds from reaching ear canal 3 and eardrum 4. See id. at 2:38-42, 5:4-15, 5:24-27, 5:66-6:10.

Electronics unit 11 of the ear terminal comprises a microprocessor connected to: external microphone M1 to record sound in the external environment; internal microphone M2 to record sound within ear canal 3; and sound generator (loudspeaker) SG to generate sound within ear canal 3. See id. at FIG. 2, 5:13-18, 6:10-21, 7:4-15.

Svean indicates “it is critically important to avoid leakage of the noise sound through or around the sealing” provided by receipt of the ear terminal with a user's ear, so one object of Svean's invention is “to provide a device for verifying in situ that a hearing protector is properly used” via “an in situ acoustical measurement, which is analyzed and reported to the user.” Id. at 3:38-4:10. In particular, electronics unit 11 causes speaker SG to generate a predetermined acoustic measurement signal, and then analyzes the resulting sound recorded by internal microphone M2. See id. at 5:49-54, 11:61-12:9, 12:31-41. “The result of the analysis is compared to stored results from previous measurements of the same type in a situation with good sealing conditions,” and the user is notified “if the leakage is acceptably low” or alternatively is warned “if leakage is unacceptably high.” Id. at 12:9-14.

FIG. 8 of Svean illustrates an exemplary analysis that can be implemented by electronics unit 11 to determine whether seal leakage is acceptably low or unacceptably high.

FIG. 8 of Svean depicts a signal processing scheme to verify hearing protector performance. See id. at 4:49-51, 12:41-42. In blocks 81 and 82, electronics unit 11 generates “two pure tones of different frequencies f1 and f2,” both of which comprise an “in-phase (sin)” component and an “out-of-phase (cos)” component. Id. at 12:42-56. In block 83, the two in-phase (sin) components are added together, and electronics unit 11 then causes speaker SG to generate a corresponding sound within the user's ear canal 3. See id. at 12:56-58. “The resulting sound field is picked up by” internal microphone M2 within the user's ear canal 3, “and analysed by algorithms in [electronics unit 11] for a series of detectors represented by blocks 84, 85, 86 and 87.” Id. at 12:58-61.

In that analysis: “The in-phase and out-of-phase components of the microphone M2 signal are analysed for each of the two frequencies” f1 and f2. Id. at 12:61-63. Thus, detector 84 analyzes the in-phase component of the frequency f1 signal from microphone M2, detector 85 analyzes the out-of-phase component of the frequency f1 signal from microphone M2, detector 86 analyzes the in-phase component of the frequency f2 signal from microphone M2, and detector 87 analyzes the out-of-phase component of the frequency f2 signal from microphone M2. See id. at FIG. 8, 12:61-63. As shown in FIG. 8, each detector has two inputs: (1) the internal microphone M2 signal, and (2) frequency generator 81 for detectors 84 and 85, or frequency generator 82 for detectors 86 and 87. See id. at FIG. 8. “The detector algorithm performs a sample by sample multiplication of the two input signals and smoothes the result with a low-pass filter.” Id. at 12:63-66.

In block 88: “The four detector outputs are applied to a decision algorithm . . . where they are compared to stored values . . . from previous measurements of the same type in a situation with good sealing conditions.” Id. at 12:66-13:6. The decision indicates either “acceptable noise protection attenuation or unacceptable protection conditions.” Id. at 13:1-4. “The stored values for the decision algorithm may according to a preferred embodiment be based on previous laboratory experiments, but values for the decision algorithm may also be determined, e.g. making an average and setting a lower acceptance limit for a general-purpose embodiment of the invention.” Id. at 13:7-11.

“ . . . we are unable to find any disclosure in Svean that these two signals are compared, either by detectors 84, 85, 86, and 87, or by decision algorithm 88. Instead, Svean describes how the four detectors use “algorithms” which “analyse[] . . . [t]he in-phase and out-of-phase components of the microphone M2 signal [(blue)] for each of the two frequencies” by “perform[ing] a sample by sample multiplication of the two input signals and smooth[ing] the result with a low-pass filter.” Id. at 12:58-66. This disclosure does not indicate that the detectors compare the microphone signal and the test fit signal as part of performing their algorithms. Instead, this disclosure indicates that the two signals are multiplied.

Svean finally discloses that, as an alternative to comparing the microphone signal or some derivative thereof to previously stored data reflecting good sealing conditions, “values for the decision algorithm may also be determined, e.g. making an average and setting a lower acceptance limit for a general-purpose embodiment of the invention.” Id. at 13:8-11. No further detail is given for this alternative embodiment. See id. It is not clear to us how this disclosure might reflect that the microphone signal and the test fit signal are compared See Ex. 1002 ¶¶ 52, 55, 64, 67-68.

For the foregoing reasons, we conclude Svean's disclosure does not support, . . . that Svean discloses comparing a microphone signal to a test fit signal.

One of the current issues with sealing determination methods is that larger frequencies tend to be unhelpful in leak determination, it would be useful to have a system that can use higher frequencies (>500 Hz) to determine seal quality.

### SUMMARY

Devices, system and methods for detecting seal quality are disclosed.

At least one exemplary embodiment is directed to a method of determining whether a channel is sealed by a device, by sending a first signal to a speaker, emitting audio content from the speaker in response to the speaker receiving the first signal, wherein the audio content is emitted into a chamber formed by a device inserted into a channel, wherein the speaker is in the device, measuring sound in the chamber with a microphone, wherein the microphone generates a microphone signal and wherein the microphone is in the device, converting the microphone signal into a spectrum, generating a ratio of intensities of the spectrum at a selected frequency, fs, and a multiple of the selected frequency mfs; and comparing the ratio to a threshold value to determine whether the device is adequately sealed in the channel.

At least one exemplary embodiment determines whether the device is adequately sealed in the channel when the ratio<threshold.

Whereas another exemplary embodiment determines whether the device is adequately sealed in the channel when the ratio>threshold.

At least one exemplary embodiment determines whether the device is adequately sealed by sending a first signal to a speaker, wherein the first signal has a peak selected frequency fs, wherein fs>450 H, emitting an audio content from the speaker in response to the speaker receiving the first signal, wherein the audio content is emitted into a chamber formed by a device inserted into a channel, wherein the speaker is in the device, measuring sound in the chamber with a microphone, wherein the microphone generates a microphone signal and wherein the microphone is in the device, converting the microphone signal into a spectrum, generating a difference of intensities of the spectrum at a multiple of the selected frequency mfs, wherein the multiple m>2; and comparing the difference to a threshold value to determine whether the device is adequately sealed in the channel.

At least one exemplary embodiment determines whether the device is adequately sealed in the channel when the difference<threshold.

These and other features of earseal systems and methods are described in the following detailed description, drawings, and appended claims.

### BRIEF DESCRIPTION OF THE DRAWINGS

FIG. 1 is a schematic diagram of a system for utilizing eartips according to an embodiment of the present disclosure.

FIG. 2A illustrates a generic cross section of an ear canal.

FIG. 2B illustrates the general outer physiology of an ear.

FIG. 3 is a schematic diagram of a machine in the form of a computer system within which a set of instructions, when executed, may cause the machine to perform any one or more of the methodologies or operations of the systems and methods for utilizing an eartip according to embodiments of the present disclosure.

FIG. 4 illustrates an example of a device configured to seal a channel, in this case an earphone device.

FIG. 5 illustrates a block diagram of an electronics package.

FIG. 6A illustrates a device inserted into a channel.

FIG. 6B illustrates a block diagram of the electronics package of the device in FIG. 6A, wherein the speaker emits an audio content.

FIG. 7 illustrates a block diagram of components in an electronic package of the device illustrated in FIG. 6A.

FIG. 8 illustrates an intensity spectrum within range from 0 Hz to 1800 Hz.

FIG. 9 illustrates a method in accordance with one of the embodiments.

### DETAILED DESCRIPTION OF THE INVENTION

Exemplary embodiments of seal detection for earphone devices, and systems and methods therefore are disclosed.

Exemplary embodiments are directed to or can be operatively used on various earphone, hearing aids or other electronic wired or wireless earpiece devices (e.g., hearing aids, ear monitors, headphones, ear terminal, behind the ear devices or other acoustic devices as known by one of ordinary skill, and equivalents). For example, the earpieces can have one or more transducers (e.g. ambient sound microphone (ASM), ear canal microphone (ECM), ear canal receiver (ECR/SPKR)) for monitoring/providing sound. In all of the examples illustrated and discussed herein, any specific values should be interpreted to be illustrative only and non-limiting. Thus, other examples of the exemplary embodiments could have different values.

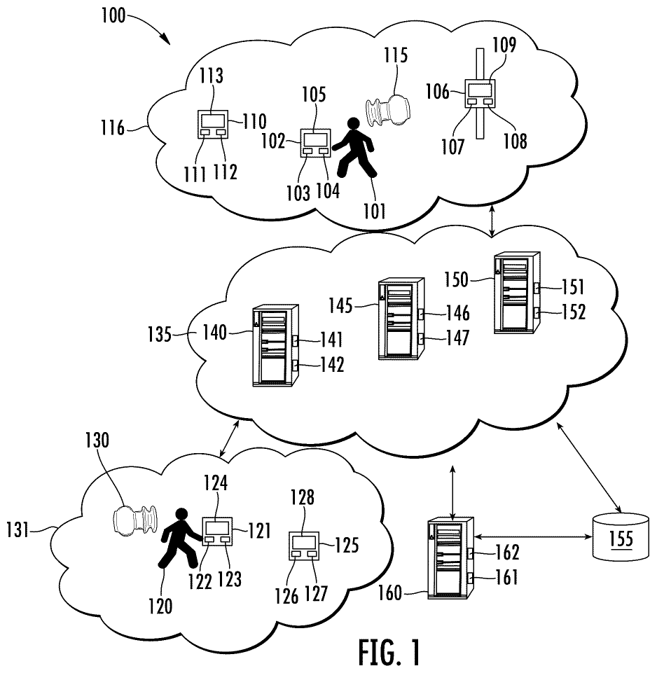

As shown in FIG. 1, a system 100 that is configured to be used with a device (e.g., 115) in a channel (e.g., pipe, ear canal), where the earphone device 115 is intended to at least partially seal the channel is disclosed. Such devices can include sensors, microphones that utilize various processors, network communications and data transfer systems. As system 100 utilizing the earphone device 115 is illustrated in FIG. 1.

The system 100 may be configured to support, but is not limited to supporting, data and content services, audio processing applications and services, audio output and/or input applications and services, applications and services for transmitting and receiving audio content, authentication applications and services, computing applications and services, cloud computing services, internet services, satellite services, telephone services, software as a service (Saas) applications, platform-as-a-service (PaaS) applications, gaming applications and services, social media applications and services, productivity applications and services, voice-over-internet protocol (VoIP) applications and services, speech-to-text translation applications and services, interactive voice applications and services, mobile applications and services, and any other computing applications and services. The system may include a first user 101, who may utilize a first user device 102 to access data, content, and applications, or to perform a variety of other tasks and functions. As an example, the first user 101 may utilize first user device 102 to access an application (e.g. a browser or a mobile application) executing on the first user device 102 that may be utilized to access web pages, data, and content associated with the system 100. In certain embodiments, the first user 101 may be any type of user that may potentially desire to listen to audio content, such as from, but not limited to, a music playlist accessible via the first user device 102, a telephone call that the first user 101 is participating in, audio content occurring in an environment in proximity to the first user 101, any other type of audio content, or a combination thereof. For example, the first user 101 may be an individual that may be participating in a telephone call with another user, such as second user 120.

The first user device 102 utilized by the first user 101 may include a memory 103 that includes instructions, and a processor 104 that executes the instructions from the memory 103 to perform the various operations that are performed by the first user device 102. In certain embodiments, the processor 104 may be hardware, software, or a combination thereof. The first user device 102 may also include an interface 105 (e.g. screen, monitor, graphical user interface, etc.) that may enable the first user 101 to interact with various applications executing on the first user device 102, to interact with various applications executing within the system 100, and to interact with the system 100 itself. In certain embodiments, the first user device 102 may include any number of transducers, such as, but not limited to, microphones, speakers, any type of audio-based transducer, any type of transducer, or a combination thereof. In certain embodiments, the first user device 102 may be a computer, a laptop, a tablet device, a phablet, a server, a mobile device, a smartphone, a smart watch, and/or any other type of computing device. Illustratively, the first user device 102 is shown as a mobile device in FIG. 1. The first user device 102 may also include a global positioning system (GPS), which may include a GPS receiver and any other necessary components for enabling GPS functionality, accelerometers, gyroscopes, sensors, and any other componentry suitable for a mobile device. Note that the description herein for devices 102, 106 is applicable for earphone device 115.

In addition to using first user device 102, the first user 101 may also utilize and/or have access to a second user device 106 and a third user device 110. As with first user device 102, the first user 101 may utilize the second and third user devices 106, 110 to transmit signals to access various online services and content. The second user device 106 may include a memory 107 that includes instructions, and a processor 108 that executes the instructions from the memory 107 to perform the various operations that are performed by the second user device 106. In certain embodiments, the processor 108 may be hardware, software, or a combination thereof. The second user device 106 may also include an interface 109 that may enable the first user 101 to interact with various applications executing on the second user device 106 and to interact with the system 100. In certain embodiments, the second user device 106 may include any number of transducers, such as, but not limited to, microphones, speakers, any type of audio-based transducer, any type of transducer, or a combination thereof. In certain embodiments, the second user device 106 may be and/or may include a computer, any type of sensor, a laptop, a set-top-box, a tablet device, a phablet, a server, a mobile device, a smartphone, a smart watch, and/or any other type of computing device. Illustratively, the second user device 102 is shown as a smart watch device in FIG. 1.

The third user device 110 may include a memory 111 that includes instructions, and a processor 112 that executes the instructions from the memory 111 to perform the various operations that are performed by the third user device 110. In certain embodiments, the processor 112 may be hardware, software, or a combination thereof. The third user device 110 may also include an interface 113 that may enable the first user 101 to interact with various applications executing on the second user device 106 and to interact with the system 100. In certain embodiments, the third user device 110 may include any number of transducers, such as, but not limited to, microphones, speakers, any type of audio-based transducer, any type of transducer, or a combination thereof. In certain embodiments, the third user device 110 may be and/or may include a computer, any type of sensor, a laptop, a set-top-box, a tablet device, a phablet, a server, a mobile device, a smartphone, a smart watch, and/or any other type of computing device. Illustratively, the third user device 110 is shown as a smart watch device in FIG. 1.

The first, second, and/or third user devices 102, 106, 110 may belong to and/or form a communications network 116. In certain embodiments, the communications network 116 may be a local, mesh, or other network that facilitates communications among the first, second, and/or third user devices 102, 106, 110 and/or any other devices, programs, and/or networks of system 100 or outside system 100. In certain embodiments, the communications network 116 may be formed between the first, second, and third user devices 102, 106, 110 through the use of any type of wireless or other protocol and/or technology. For example, the first, second, and third user devices 102, 106, 110 may communicate with one another in the communications network 116, such as by utilizing Bluetooth Low Energy (BLE), classic Bluetooth, ZigBee, cellular, NFC, Wi-Fi, Z-Wave, ANT+, IEEE 802.15.4, IEEE 802.22, ISA100a, infrared, ISM band, RFID, UWB, Wireless HD, Wireless USB, any other protocol and/or wireless technology, satellite, fiber, or any combination thereof. Notably, the communications network 116 may be configured to communicatively link with and/or communicate with any other network of the system 100 and/or outside the system 100.

The system 100 may also include an earphone device 115, which the first user 101 may utilize to hear and/or audition audio content, transmit audio content, receive audio content, experience any type of content, process audio content, adjust audio content, store audio content, perform any type of operation with respect to audio content, or a combination thereof. The earphone device 115 may be an earpiece, a hearing aid, an ear monitor, an ear terminal, a behind-the-ear device, any type of acoustic device, or a combination thereof. The earphone device 115 may include any type of component utilized for any type of earpiece. In certain embodiments, the earphone device 115 may include any number of ambient sound microphones that may be configured to capture and/or measure ambient sounds and/or audio content occurring in an environment that the earphone device 115 is present in and/or is proximate to. In certain embodiments, the ambient sound microphones may be placed at a location or locations on the earphone device 115 that are conducive to capturing and measuring ambient sounds occurring in the environment. For example, the ambient sound microphones may be positioned in proximity to a distal end (e.g. the end of the earphone device 115 that is not inserted into the first user's 101 ear) of the earphone device 115 such that the ambient sound microphones are in an optimal position to capture ambient or other sounds occurring in the environment. In certain embodiments, the earphone device 115 may include any number of ear canal microphones, which may be configured to capture and/or measure sounds occurring in an ear canal of the first user 101 or other user wearing the earphone device 115. In certain embodiments, the ear canal microphones may be positioned in proximity to a proximal end (e.g. the end of the earphone device 115 that is inserted into the first user's 101 ear) of the earphone device 115 such that sounds occurring in the ear canal of the first user 101 may be captured more readily.

The earphone device 115 may also include any number of transceivers, which may be configured transmit signals to and/or receive signals from any of the devices in the system 100. In certain embodiments, a transceiver of the earphone device 115 may facilitate wireless connections and/or transmissions between the earphone device 115 and any device in the system 100, such as, but not limited to, the first user device 102, the second user device 106, the third user device 110, the fourth user device 121, the fifth user device 125, the earphone device 130, the servers 140, 145, 150, 160, and the database 155. The earphone device 115 may also include any number of memories for storing content and/or instructions, processors that execute the instructions from the memories to perform the operations for the earphone device 115, and/or any type integrated circuit for facilitating the operation of the earphone device 115. In certain embodiments, the processors may comprise, hardware, software, or a combination of hardware and software. The earphone device 115 may also include one or more ear canal receivers, which may be speakers for outputting sound into the ear canal of the first user 101. The ear canal receivers may output sounds obtained via the ear canal microphones, ambient sound microphones, any of the devices in the system 100, from a storage device of the earphone device 115, or any combination thereof.

The ear canal receivers, ear canal microphones, transceivers, memories, processors, integrated circuits, and/or ear canal receivers may be affixed to an electronics package that includes a flexible electronics board. The earphone device 115 may include an electronics packaging housing that may house the ambient sound microphones, ear canal microphones, ear canal receivers (i.e. speakers), electronics supporting the functionality of the microphones and/or receivers, transceivers for receiving and/or transmitting signals, power sources (e.g. batteries and the like), any circuitry facilitating the operation of the earphone device 115, or any combination thereof. The electronics package including the flexible electronics board may be housed within the electronics packaging housing to form an electronics packaging unit. The earphone device 115 may further include an earphone housing, which may include receptacles, openings, and/or keyed recesses for connecting the earphone housing to the electronics packaging housing and/or the electronics package. For example, nozzles of the electronics packaging housing may be inserted into one or more keyed recesses of the earphone housing so as to connect and secure the earphone housing to the electronics packaging housing. When the earphone housing is connected to the electronics packaging housing, the combination of the earphone housing and the electronics packaging housing may form the earphone device 115. The earphone device 115 may further include a cap for securing the electronics packaging housing, the earphone housing, and the electronics package together to form the earphone device 115.

In certain embodiments, the earphone device 115 may be configured to have any number of changeable tips, which may be utilized to facilitate the insertion of the earphone device 115 past an ear aperture of an ear of the first user 101, secure the earphone device 115 within the ear canal of an ear of the first user 101, and/or to isolate sound within the ear canal of the first user 101. The tips may be foam tips, which may be affixed onto an end of the earphone housing of the earphone device 115, such as onto a stent and/or attachment mechanism of the earphone housing. In certain embodiments, the tips may be any type of eartip as disclosed and described in the present disclosure. The eartips as disclosed in the present disclosure may be configured to facilitate distributed reduced contact force, sound isolation for sound in the ear canal of the first user 101 (i.e. between the ambient environment and the ear canal environment within an ear of the first user 101), mold into a variety of forms and/or positions, encapsulate volumes upon insertion into an ear aperture of the first user 101, have a pressure adjusting design, facilitate notched stent retention (i.e. on a stent of the earphone housing), facilitate stent insertion into an ear canal of the first user 101 via an ear aperture of the first user 101, or any combination thereof. In certain embodiments, the eartip may be designed to provide sound isolation capability that is at least as effective as conventional foam and/or flange tips. Notably, the eartips may be manufactured and configured to be made in any desired size specifications and/or materials, and may be tailored to each individual user, such as first user 101. In contrast to conventional foam or flange tips, an eartip according to the present disclosure may be adjusted for size without having to substitute the eartip with another eartip, may have an EPA NRR rating of NRR=18, may have a unique flatter high frequency attenuation profile so as to maintain audio quality, may have ease of manufacturability, and may be designed to distribute contact force and minimize radial force against a user's ear canal walls when positioned in a user's ear canal. Additionally, an eartip according to the present disclosure may be made of a non-porous material that is not closed cell foam or open cell foam.

In certain embodiments, the eartip may be designed so that the earphone device's 115 retention force on the ear canal walls of the first user 101 may be distributed over a larger area than traditional foam or flange tips allow, thereby reducing the pressure on the ear canal walls of the first user 10. Unlike foam tips, which primarily provide a restoring radial force that exerts pressure against the ear canal walls of a user, the eartip is designed to move both radially and axially, which allows for more give and redistribution of contact over a larger area, and, thus, decreases the retention pressure. As a result, this allows for increased comfort for the user and allows the user to utilize the eartip for an extended period of time when compared to traditional foam and/or flange tips. In certain embodiments, the eartip utilized with the earphone device 115 may be configured to encapsulate a volume of gas and/or liquid. In either case (i.e. gas or liquid), the bulk of sound isolation provided by the eartip is achieved through the reflection of ambient sound waves so that the encapsulated volume can be low mass. In certain embodiments, portions of the eartip may encapsulate a volume with the ability to release volume when pressed upon without having to incorporate complicated valves. The encapsulated volume may be achieved by the ear canal wall pressing radially and/or axially against the outer surfaces of the eartip, which may force the outer portion of the eartip to seal with the inner portion of the eartip. In certain embodiments, the inner portion of the eartip may be small than the outer diameter of the stent of the earphone housing upon which the eartip is placed so that upon insertion of the eartip on the stent, the inner portion stretches outward to meet the outer surface of the eartip, which further facilitates the sealing of the ear canal of the first user 101.

In addition to the first user 101, the system 100 may include a second user 120, who may utilize a fourth user device 121 to access data, content, and applications, or to perform a variety of other tasks and functions. Much like the first user 101, the second user 120 may be may be any type of user that may potentially desire to listen to audio content, such as from, but not limited to, a storage device of the fourth user device 121, a telephone call that the second user 120 is participating in, audio content occurring in an environment in proximity to the second user 120, any other type of audio content, or a combination thereof. For example, the second user 120 may be an individual that may be listening to songs stored in a playlist that resides on the fourth user device 121. Also, much like the first user 101, the second user 120 may utilize fourth user device 121 to access an application (e.g. a browser or a mobile application) executing on the fourth user device 121 that may be utilized to access web pages, data, and content associated with the system 100. The fourth user device 121 may include a memory 122 that includes instructions, and a processor 123 that executes the instructions from the memory 122 to perform the various operations that are performed by the fourth user device 121. In certain embodiments, the processor 123 may be hardware, software, or a combination thereof. The fourth user device 121 may also include an interface 124 (e.g. a screen, a monitor, a graphical user interface, etc.) that may enable the second user 120 to interact with various applications executing on the fourth user device 121, to interact with various applications executing in the system 100, and to interact with the system 100. In certain embodiments, the fourth user device 121 may include any number of transducers, such as, but not limited to, microphones, speakers, any type of audio-based transducer, any type of transducer, or a combination thereof. In certain embodiments, the fourth user device 121 may be a computer, a laptop, a tablet device, a phablet, a server, a mobile device, a smartphone, a smart watch, and/or any other type of computing device. Illustratively, the fourth user device 121 may be a computing device in FIG. 1. The fourth user device 121 may also include any of the componentry described for first user device 102, the second user device 106, and/or the third user device 110. In certain embodiments, the fourth user device 121 may also include a global positioning system (GPS), which may include a GPS receiver and any other necessary components for enabling GPS functionality, accelerometers, gyroscopes, sensors, and any other componentry suitable for a computing device.

In addition to using fourth user device 121, the second user 120 may also utilize and/or have access to a fifth user device 125. As with fourth user device 121, the second user 120 may utilize the fourth and fifth user devices 121, 125 to transmit signals to access various online services and content. The fifth user device 125 may include a memory 126 that includes instructions, and a processor 127 that executes the instructions from the memory 126 to perform the various operations that are performed by the fifth user device 125. In certain embodiments, the processor 127 may be hardware, software, or a combination thereof. The fifth user device 125 may also include an interface 128 that may enable the second user 120 to interact with various applications executing on the fifth user device 125 and to interact with the system 100. In certain embodiments, the fifth user device 125 may include any number of transducers, such as, but not limited to, microphones, speakers, any type of audio-based transducer, any type of transducer, or a combination thereof. In certain embodiments, the fifth user device 125 may be and/or may include a computer, any type of sensor, a laptop, a set-top-box, a tablet device, a phablet, a server, a mobile device, a smartphone, a smart watch, and/or any other type of computing device. Illustratively, the fifth user device 125 is shown as a tablet device in FIG. 1.

The fourth and fifth user devices 121, 125 may belong to and/or form a communications network 131. In certain embodiments, the communications network 131 may be a local, mesh, or other network that facilitates communications between the fourth and fifth user devices 121, 125, and/or any other devices, programs, and/or networks of system 100 or outside system 100. In certain embodiments, the communications network 131 may be formed between the fourth and fifth user devices 121, 125 through the use of any type of wireless or other protocol and/or technology. For example, the fourth and fifth user devices 121, 125 may communicate with one another in the communications network 116, such as by utilizing BLE, classic Bluetooth, ZigBee, cellular, NFC, Wi-Fi, Z-Wave, ANT+, IEEE 802.15.4, IEEE 802.22, ISA100a, infrared, ISM band, RFID, UWB, Wireless HD, Wireless USB, any other protocol and/or wireless technology, satellite, fiber, or any combination thereof. Notably, the communications network 131 may be configured to communicatively link with and/or communicate with any other network of the system 100 and/or outside the system 100.

Much like first user 101, the second user 120 may have his or her own earphone device 130. The earphone device 130 may be utilized by the second user 120 to hear and/or audition audio content, transmit audio content, receive audio content, experience any type of content, process audio content, adjust audio content, store audio content, perform any type of operation with respect to audio content, or a combination thereof. The earphone device 130 may be an earpiece, a hearing aid, an ear monitor, an ear terminal, a behind-the-ear device, any type of acoustic device, or a combination thereof. The earphone device 130 may include any type of component utilized for any type of earpiece, and may include any of the features, functionality and/or components described and/or usable with earphone device 115. For example, earphone device 130 may include any number of transceivers, ear canal microphones, ambient sound microphones, processors, memories, housings, eartips, foam tips, flanges, any other component, or any combination thereof.

In certain embodiments, the first, second, third, fourth, and/or fifth user devices 102, 106, 110, 121, 125 and/or earphone devices 115, 130 may have any number of software applications and/or application services stored and/or accessible thereon. For example, the first and second user devices 102, 111 may include applications for processing audio content, applications for playing, editing, transmitting, and/or receiving audio content, streaming media applications, speech-to-text translation applications, cloud-based applications, search engine applications, natural language processing applications, database applications, algorithmic applications, phone-based applications, product-ordering applications, business applications, e-commerce applications, media streaming applications, content-based applications, database applications, gaming applications, internet-based applications, browser applications, mobile applications, service-based applications, productivity applications, video applications, music applications, social media applications, presentation applications, any other type of applications, any types of application services, or a combination thereof. In certain embodiments, the software applications and services may include one or more graphical user interfaces so as to enable the first and second users 101, 120 to readily interact with the software applications. The software applications and services may also be utilized by the first and second users 101, 120 to interact with any device in the system 100, any network in the system 100 (e.g. communications networks 116, 131, 135), or any combination thereof. For example, the software applications executing on the first, second, third, fourth, and/or fifth user devices 102, 106, 110, 121, 125 and/or earphone devices 115, 130 may be applications for receiving data, applications for storing data, applications for auditioning, editing, storing and/or processing audio content, applications for receiving demographic and preference information, applications for transforming data, applications for executing mathematical algorithms, applications for generating and transmitting electronic messages, applications for generating and transmitting various types of content, any other type of applications, or a combination thereof. In certain embodiments, the first, second, third, fourth, and/or fifth user devices 102, 106, 110, 121, 125 and/or earphone devices 115, 130 may include associated telephone numbers, internet protocol addresses, device identities, or any other identifiers to uniquely identify the first, second, third, fourth, and/or fifth user devices 102, 106, 110, 121, 125 and/or earphone devices 115, 130 and/or the first and second users 101, 120. In certain embodiments, location information corresponding to the first, second, third, fourth, and/or fifth user devices 102, 106, 110, 121, 125 and/or earphone devices 115, 130 may be obtained based on the internet protocol addresses, by receiving a signal from the first, second, third, fourth, and/or fifth user devices 102, 106, 110, 121, 125 and/or earphone devices 115, 130 or based on profile information corresponding to the first, second, third, fourth, and/or fifth user devices 102, 106, 110, 121, 125 and/or earphone devices 115, 130.

The system 100 may also include a communications network 135. The communications network 135 may be under the control of a service provider, the first and/or second users 101, 120, any other designated user, or a combination thereof. The communications network 135 of the system 100 may be configured to link each of the devices in the system 100 to one another. For example, the communications network 135 may be utilized by the first user device 102 to connect with other devices within or outside communications network 135. Additionally, the communications network 135 may be configured to transmit, generate, and receive any information and data traversing the system 100. In certain embodiments, the communications network 135 may include any number of servers, databases, or other componentry. The communications network 135 may also include and be connected to a mesh network, a local network, a cloud-computing network, an IMS network, a VoIP network, a security network, a VoLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 140, 145, and 150 are shown as being included within communications network 135. In certain embodiments, the communications network 135 may be part of a single autonomous system that is located in a particular geographic region, or be part of multiple autonomous systems that span several geographic regions.

Notably, the functionality of the system 100 may be supported and executed by using any combination of the servers 140, 145, 150, and 160. The servers 140, 145, and 150 may reside in communications network 135, however, in certain embodiments, the servers 140, 145, 150 may reside outside communications network 135. The servers 140, 145, and 150 may provide and serve as a server service that performs the various operations and functions provided by the system 100. In certain embodiments, the server 140 may include a memory 141 that includes instructions, and a processor 142 that executes the instructions from the memory 141 to perform various operations that are performed by the server 140. The processor 142 may be hardware, software, or a combination thereof. Similarly, the server 145 may include a memory 146 that includes instructions, and a processor 147 that executes the instructions from the memory 146 to perform the various operations that are performed by the server 145. Furthermore, the server 150 may include a memory 151 that includes instructions, and a processor 152 that executes the instructions from the memory 151 to perform the various operations that are performed by the server 150. In certain embodiments, the servers 140, 145, 150, and 160 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 140, 145, 150 may be communicatively linked to the communications network 135, the communications network 116, the communications network 131, any network, any device in the system 100, any program in the system 100, or any combination thereof.

The database 155 of the system 100 may be utilized to store and relay information that traverses the system 100, cache content that traverses the system 100, store data about each of the devices in the system 100 and perform any other typical functions of a database. In certain embodiments, the database 155 may be connected to or reside within the communications network 135, the communications network 116, the communications network 131, any other network, or a combination thereof. In certain embodiments, the database 155 may serve as a central repository for any information associated with any of the devices and information associated with the system 100. Furthermore, the database 155 may include a processor and memory or be connected to a processor and memory to perform the various operation associated with the database 155. In certain embodiments, the database 155 may be connected to the earphone devices 115, 130, the servers 140, 145, 150, 160, the first user device 102, the second user device 106, the third user device 110, the fourth user device 121, the fifth user device 125, any devices in the system 100, any other device, any network, or any combination thereof.

The database 155 may also store information and metadata obtained from the system 100, store metadata and other information associated with the first and second users 101, 120, store user profiles associated with the first and second users 101, 120, store device profiles associated with any device in the system 100, store communications traversing the system 100, store user preferences, store information associated with any device or signal in the system 100, store information relating to patterns of usage relating to the first, second, third, fourth, and fifth user devices 102, 106, 110, 121, 125, store audio content associated with the first, second, third, fourth, and fifth user devices 102, 106, 110, 121, 125 and/or earphone devices 115, 130, store audio content and/or information associated with the audio content that is captured by the ambient sound microphones, store audio content and/or information associated with audio content that is captured by ear canal microphones, store any information obtained from any of the networks in the system 100, store audio content and/or information associated with audio content that is outputted by ear canal receivers of the system 100, store any information and/or signals transmitted and/or received by transceivers of the system 100, store any device and/or capability specifications relating to the earphone devices 115, 130, store historical data associated with the first and second users 101, 120, store information relating to the size (e.g. depth, height, width, curvatures, etc.) and/or shape of the first and/or second user's 101, 120 ear canals and/or ears, store information identifying and or describing any eartip utilized with the earphone devices 101, 115, store device characteristics for any of the devices in the system 100, store information relating to any devices associated with the first and second users 101, 120, store any information associated with the earphone devices 115, 130, store log on sequences and/or authentication information for accessing any of the devices of the system 100, store information associated with the communications networks 116, 131, store any information generated and/or processed by the system 100, store any of the information disclosed for any of the operations and functions disclosed for the system 100 herewith, store any information traversing the system 100, or any combination thereof. Furthermore, the database 155 may be configured to process queries sent to it by any device in the system 100.

The system 100 may also include a software application, which may be configured to perform and support the operative functions of the system 100, such as the operative functions of the first, second, third, fourth, and fifth user devices 102, 106, 110, 121, 125 and/or the earphone devices 115, 130. In certain embodiments, the application may be a website, a mobile application, a software application, or a combination thereof, which may be made accessible to users utilizing one or more computing devices, such as the first, second, third, fourth, and fifth user devices 102, 106, 110, 121, 125 and/or the earphone devices 115, 130. The application of the system 100 may be accessible via an internet connection established with a browser program or other application executing on the first, second, third, fourth, and fifth user devices 102, 106, 110, 121, 125 and/or the earphone devices 115, 130, a mobile application executing on the first, second, third, fourth, and fifth user devices 102, 106, 110, 121, 125 and/or the earphone devices 115, 130, or through other suitable means. Additionally, the application may allow users and computing devices to create accounts with the application and sign-in to the created accounts with authenticating username and password log-in combinations. The application may include a custom graphical user interface that the first user 101 or second user 120 may interact with by utilizing a browser executing on the first, second, third, fourth, and fifth user devices 102, 106, 110, 121, 125 and/or the earphone devices 115, 130. In certain embodiments, the software application may execute directly as an installed program on the first, second, third, fourth, and fifth user devices 102, 106, 110, 121, 125 and/or the earphone devices 115, 130.

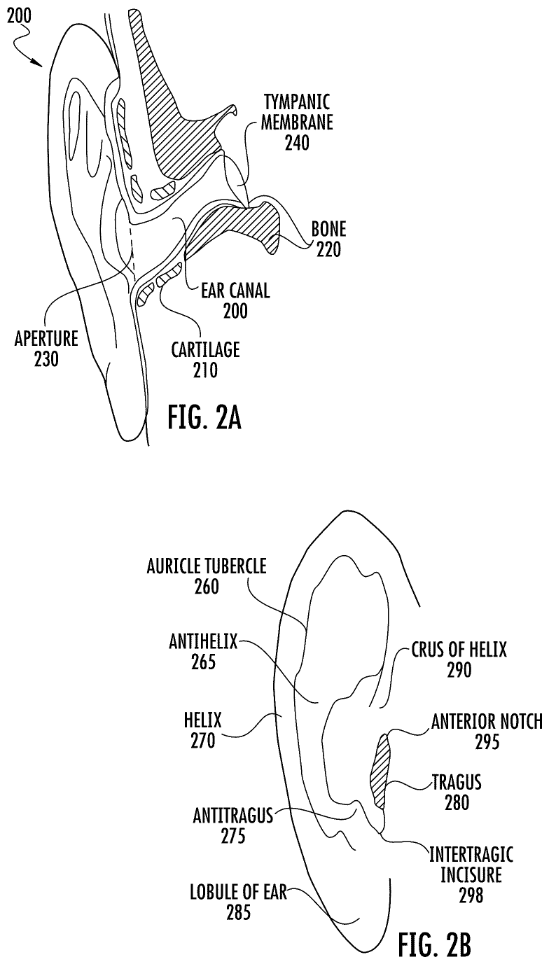

FIG. 2A illustrates a cross section of an ear canal 200, including a cartilaginous region 210 and a bony region 220 of an ear canal 200. The entrance of the ear canal 200 is referred to as the aperture 230 and defines a first end of the ear canal 200 while the tympanic membrane 240 defines the other, internal end of the ear canal 200. FIG. 2B illustrates the outer physiology of ear 200, which includes an auricle tubercle 260, the antihelix 265, the helix 270, the antitragus 275, tragus 280, lobule 285 of ear 200, crus of helix 290, anterior notch 295, and intertragic incisures 298.

### Computing System for Facilitating the Operation and Functionality of the System

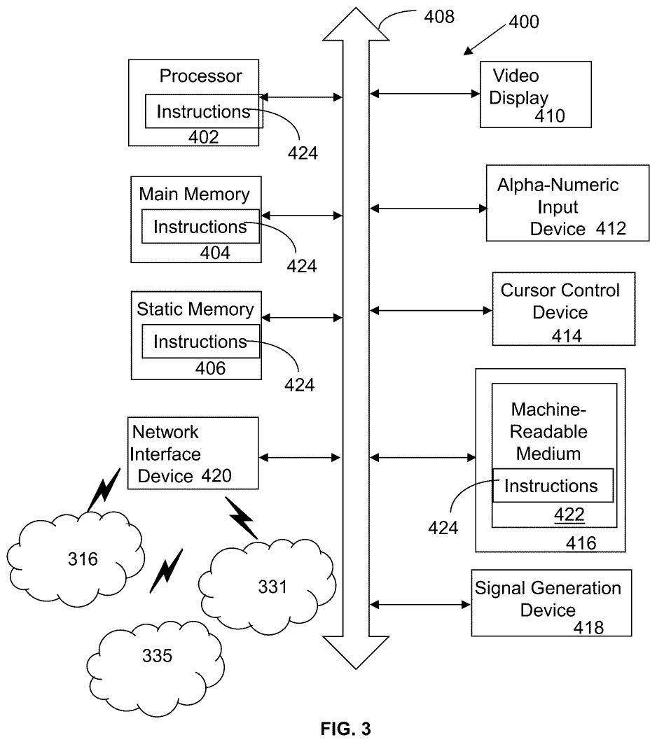

Referring now also to FIG. 3, at least a portion of the methodologies and techniques described with respect to the exemplary embodiments of the system 100 can incorporate a machine, such as, but not limited to, computer system 400, or other computing device within which a set of instructions, when executed, may cause the machine to perform any one or more of the methodologies or functions discussed above. Note that description herein concerning system 100 and the use of the machine is applicable for use in all devices such as earphone devices 115. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, by providing functionality and/or programs for facilitating the operative functionality of the earphone devices 115, 130, and/or the first, second, third, fourth, and fifth user devices 102, 106, 110, 121, 125 and/or the earphone devices 115, 130, by providing functionality and/or programs for facilitating operation of any of the components of the earphone devices 115, 130 (e.g. ear canal receivers, transceivers, ear canal microphones, ambient sound microphones, or by assisting with any other operations conducted by or within the system 100.

In some embodiments, the machine may operate as a standalone device. In some embodiments, the machine may be connected (e.g., using communications network 135, the communications network 116, the communications network 131, another network, or a combination thereof) to and assist with operations performed by other machines and systems, such as, but not limited to, the first user device 102, the second user device 111, the third user device 110, the fourth user device 121, the fifth user device 125, the earphone device 115, the earphone device 130, the server 140, the server 150, the database 155, the server 160, or any combination thereof. The machine may be connected with any component in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410, which may be, but is not limited to, a liquid crystal display (LCD), a flat panel, a solid state display, or a cathode ray tube (CRT). The computer system 400 may include an input device 412, such as, but not limited to, a keyboard, a cursor control device 414, such as, but not limited to, a mouse, a disk drive unit 416, a signal generation device 418, such as, but not limited to, a speaker or remote control, and a network interface device 420.

The disk drive unit 416 may include a machine-readable medium 422 on which is stored one or more sets of instructions 424, such as, but not limited to, software embodying any one or more of the methodologies or functions described herein, including those methods illustrated above. The instructions 424 may also reside, completely or at least partially, within the main memory 404, the static memory 406, or within the processor 402, or a combination thereof, during execution thereof by the computer system 400. The main memory 404 and the processor 402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 422 containing instructions 424 so that a device connected to the communications network 135, the communications network 116, the communications network 131, another network, or a combination thereof, can send or receive voice, video or data, and communicate over the communications network 135, the communications network 116, the communications network 131, another network, or a combination thereof, using the instructions. The instructions 424 may further be transmitted or received over the communications network 135, another network, or a combination thereof, via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

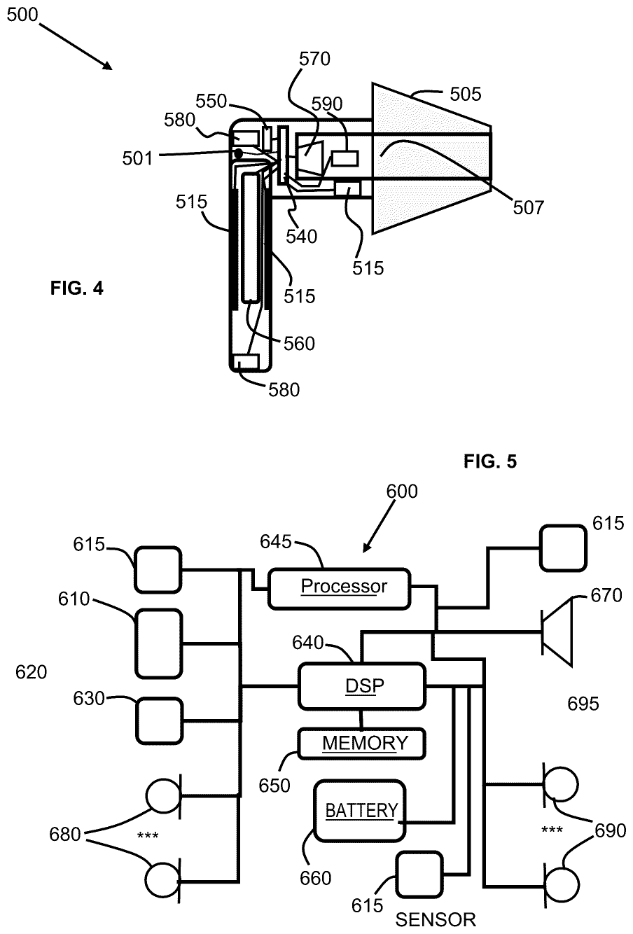

FIG. 4 illustrates an example of a device configured to seal a channel, in this case an earphone device 500. The device 500 can include an eartip 505, acoustic channel 507, an ear canal or internal microphone 590, a speaker 570, sensor(s) 515, battery 560, memory 550, ambient sound microphones 580, a processor and/or DSP 540, and LED 501. When the device is inserted into a channel (e.g., ear canal), the eartip 505 of the device 500 can form a chamber within the channel, so that the device has an inner side 695 or chamber side when used and an ambient side 620. FIG. 5 illustrates a block diagram of various component's that can be within or part of device 500.

FIG. 5 illustrates an electronics package 600 that includes the connection of various components such as sensors 615 (e.g., biosensors, accelerometers, Inertial Navigation chips, GPS chips, energy harvesting chips), processors 615 (which can also be DSP chips 640 or used with DSP chips), interactive elements 630 (e.g., buttons, haptic, touch sensitive sensor), memory 650, batteries 660, microphones (e.g. arrays or singular 680, 690), and indicator systems 610 (e.g., LED, haptic vibration). Note that the electronics package can be wired or include wireless communication chips as well, antennas, ear bone microphones. Contemporary non-limiting examples of such components can be found in current biosensor wearable devices, earphone devices, and phones. For example, the ON-Semi Ezairo 8300 chip, Knowles microphones and speakers, hearing aid batteries both non rechargeable and rechargeable.

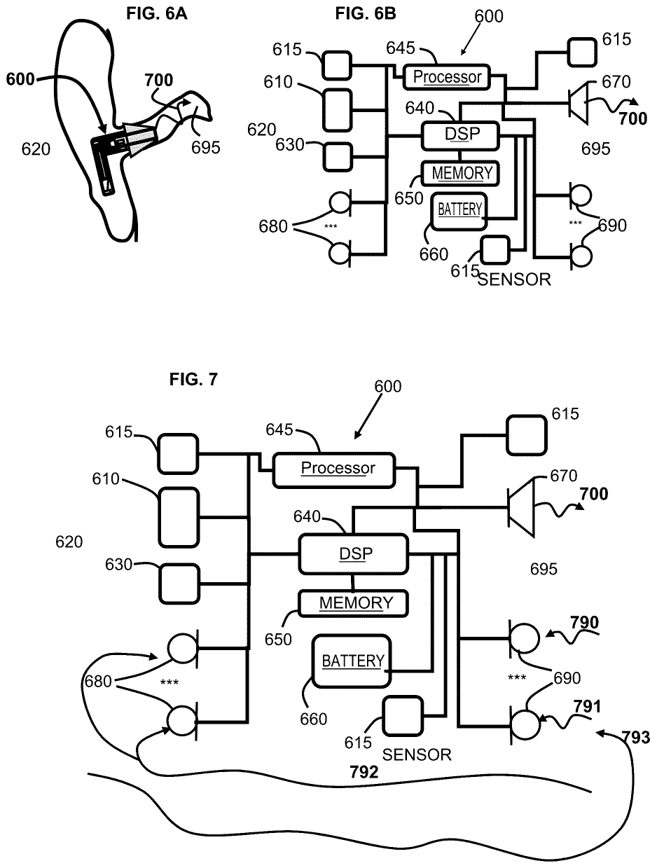

FIG. 6A illustrates the use of device 600, forming a sealed chamber 695 and an ambient side 620, emitting an audio content 700 (e.g., test signal) into the chamber 695. The equivalent electronic package is illustrated in FIG. 6B, wherein the speaker 670 emits the audio content 700. As the audio content 700 is emitted into chamber 695, microphones 690 measure sound from the chamber 695 and generate microphone signals 790, 791 (FIG. 7). If the chamber is not sealed, sound 793 from the ambient environment 620 can leak into the chamber 695. Additionally, sound 792 can leak out of the chamber 695 into the ambient 620 environment. Ambient microphones 680 can measure both sound from the ambient environment and leaked sound 792.

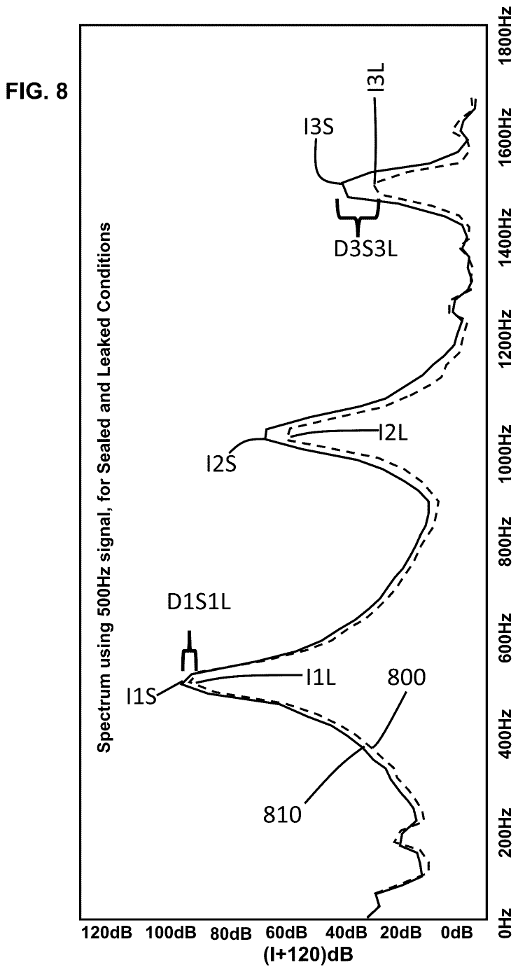

FIG. 8 illustrates intensity of microphone signals in a spectrum range from 0 Hz to 1800 Hz, where microphone signals (e.g., 790, 791) are converted into a spectrum which is examined within a range. Note that the entire spectrum measured by the microphone can be used instead of a selected range, and well as different ranges. FIG. 8 illustrates intensity data for microphone signal that measure the sound while a 500 Hz audio content signal 700 is emitted. One plot (dashed) shows the spectrum 800 for a leaky (unsealed) chamber 695, while the second spectrum 810 (solid line) represents a sealed chamber 695. Note that for this example a tone of a specific/peak frequency, fs, was emitted. The audio content can also be music, multiple frequencies as well. The intensities for the leaked condition and the sealed condition at fs are I1L and I1S respectively. Note that although intensity is shown, power spectral density or any other type of spectrum can be used. Additionally, the spectrum can be adjusted, for example as shown in FIG. 8 the actual intensities are added to 120 dB and displayed. Various other methods that help emphasize the separation between the leaked and seal condition can be used. There are various methods that can be used in exemplary embodiment that utilize various values in the spectrums. In the spectrum shown I1S=103 dB, I1L=100 dB and the difference D1S1L=3 dB. At a multiple m=2 of fs, so at 100 Hz, the leaked and sealed values are respectively I2L and I2S. Notice that the separation (e.g. difference) of the values between leaked values and sealed values increases as m increases. For example, for m=3 (i.e., at 1500 Hz), I3S=48 dB, I3L=37 dB, and D3S3L=11 dB. In at least one exemplary embodiment, the sealed condition can be determined in a lab or in real time usage where the seal has been verified for a particular channel, and stored and used to determine values that can be compared with threshold values. For example, a previously stored sealed condition spectrum 810 can be stored. Then a real time value which might result in plot 800 can be compared to determine difference values at some fs multiple m. Note that although the examples herein use m=2 and m=3, exemplary embodiments are not limited to just these two values. The difference values for example D3S3L can be comped to a threshold value, say TV=2 so that if D3S3L<TV then the device is considered adequately sealed. Another embodiment does not require stored values to generate a metric to compare to a threshold value. For example, a ratio can be used between values at fs (500 Hz) and values at mfs (e.g., 1500 Hz). The ratios themselves can be used in real time and compared to stored threshold values to determine seal quality. For example, the ratio R13S=I1S/I3S=103/48=2.145 could be used as a stored threshold value as the desirable ratio threshold for sealing. Note the equivalent leak value would be R13L=I1L/I3L=100/37=2.703. Note that the ratios could be flipped providing values of 0.4662 and 0.3699 respectively. Thus, if a spectrum is acquired from a microphone and the ratio obtains R1m, where m is the multiple, then two conditions (depending upon how the ratio is defined) can be used. If the ratios are as shown above and m=3 then R13<2.2 could be used to indicate an adequate seal. Flipping the ratios (i.e. inverting), then R31>0.4 can indicate an adequate seal. When an adequate seal is determined then function that critically rely on an adequate seal can continue or be relied upon. Additionally optional notification can be provided to a user (e.g., audio message, visual message sent to an attached communication device) that the seal is good, bad, fair poor, or any other synonym to indicate seal quality. The user can then adjust the system and start a new test. Note also that the exemplary embodiments herein can be used continuously to monitor the devices condition. Results from the seal determination can be compared with other sensors, for example biosensors such as infrared, pulsometers, and so one to provide verification of sealing or not. For example, if no infrared signal is detected that would indicate that the device is not in a user's ear.

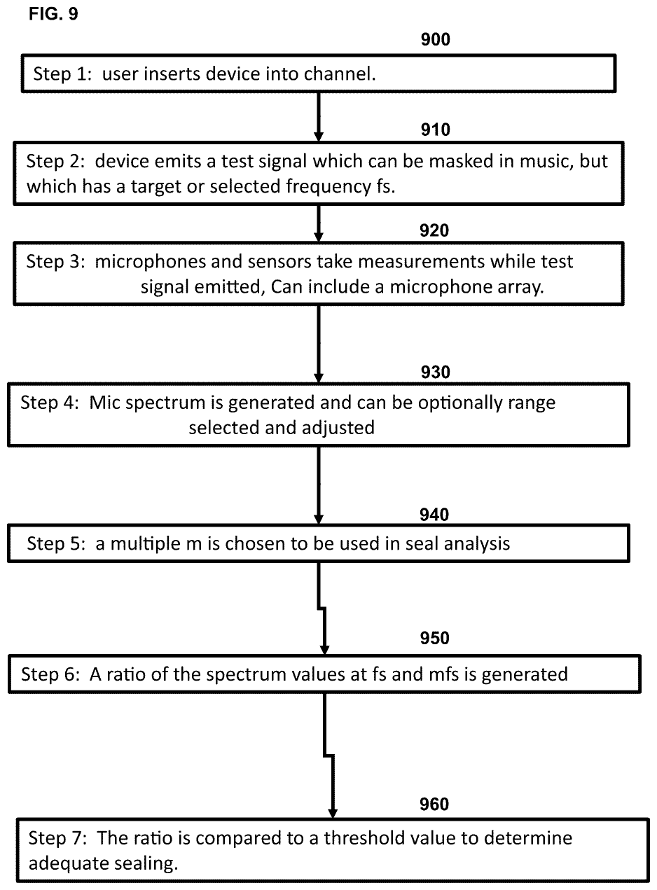

FIG. 9 illustrates a method in accordance with one of the embodiments discussed above. At step 900 a user inserts the device into a channel, wherein the device is designed or configured to at least partially seal the channel. At step 910 a processor 645 or 640 sends a test signal to a speaker 670 which emits an acoustic signal 700, wherein the acoustic signal or audio content 700 has a peak frequency fs. While the acoustic signal 700 is being emitted microphones in step 920 take measurements of the sound. Note that more than one microphone can be taking measurements and such multiple microphone signals can result in multiple spectrums resulting in multiple useful ratios than be used to verify the results. For example if ⅔rds of the ratios satisfy the adequate seal criteria (e.g., R13<2.2) then an adequate seal can be affirmatively determined, with a note in the future to check the results from the ⅓ of the microphones in an array that gives different values, incase the microphones are malfunctioning. For example if a microphone array includes 3 microphones, and if 2 of them indicate a good seal but 1 indicates a poor seal, then in one exemplary embodiment the poor seal indicator can be ignored. When the microphone signal is received a spectrum is generated. A range can be used for analysis and/or adjusted, step 930. A multiple m is chosen, either in real time or previously, to be used for analysis, step 940. In step 950 a ratio is generated using the spectrum values at fs and mfs, and the ratio is compared to a threshold value to determine adequate sealing. Note that there may be more than one threshold value for example if R13<2.2 then a good seal is indicated, if R13 is between 2.2 and 2.4 a fair seal is indicated, if R13 is between 2.4 and 2.6 a poor seal is indicated, and if R13>2.6 then a bad seal is indicated.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

I claim:

1. A method comprising:
sending a first signal to a speaker;
emitting audio content from the speaker in response to the speaker receiving the first signal, wherein the audio content is emitted into a chamber formed by a device inserted into a channel, wherein the speaker is in the device;
measuring sound in the chamber with a microphone, wherein the microphone generates a microphone signal and wherein the microphone is in the device;
converting the microphone signal into a spectrum;
generating a ratio of intensities of the spectrum at a selected frequency fs, and a multiple of the selected frequency mfs; and
comparing the ratio to a threshold value to determine whether the device is adequately sealed in the channel.

2. The method according to claim 1, wherein the first signal is a tone at frequency fs.

3. The method according to claim 2, wherein fs is between 300 Hz and 700 Hz.

4. The method according to claim 3, wherein m>2.

5. The method according to claim 3, wherein determining whether the device is adequately sealed in the channel is where the ratio<threshold value determines an adequate seal.

6. The method according to claim 3, wherein determining whether the device is adequately sealed in the channel is where the ratio>threshold value determines an adequate seal.

7. The method of claim 1, wherein the spectrum is a spectrum of the microphone signal within a frequency range that encompasses fs and mfs.

8. The method of claim 7, wherein the spectrum is adjusted so that the max intensity within the spectrum has a chosen value.

9. The method of claim 8, wherein the chosen value is 1.

10. The method of claim 8, wherein the chosen value is 100.

11. The method of claim 8, wherein the first signal is a tone at frequency fs.

12. The method of claim 11, wherein fs is between 300 Hz and 700 Hz.

13. The method of claim 12, wherein m>2.

14. The method of claim 13, wherein determining whether the device is adequately sealed in the channel is where the ratio<threshold value determines an adequate seal.

15. The method of claim 13, wherein determining whether the device is adequately sealed in the channel is where the ratio>threshold value determines an adequate seal.

16. A method comprising:
sending a first signal to a speaker, wherein the first signal has a peak selected frequency fs, wherein fs>450 Hz;
emitting audio content from the speaker in response to the speaker receiving the first signal, wherein the audio content is emitted into a chamber formed by a device inserted into a channel, wherein the speaker is in the device;
measuring sound in the chamber with a microphone, wherein the microphone generates a microphone signal and wherein the microphone is in the device;
converting the microphone signal into a spectrum;
generating a difference of intensities of the spectrum at a multiple of the selected frequency mfs, wherein the multiple m>2; and
comparing the difference to a threshold value to determine whether the device is adequately sealed in the channel.

17. The method of claim 16, wherein determining whether the device is adequately sealed in the channel is where the difference <threshold determines an adequate seal.

18. The method of claim 17, wherein the spectrum is a spectrum of the microphone signal within a frequency range that encompasses mfs, and wherein the spectrum is adjusted so that the max intensity or amplitude within the spectrum has a chosen value.

19. The method of claim 1, wherein the channel is an ear canal and the device is an earphone or hearing aid.

20. The method of claim 16, wherein the channel is an ear canal and the device is an earphone or hearing aid.
